(19) United States
(12) Patent Application Publication
(10) Pub. No.: US 2012/0118741 A1
(43) Pub. Date: May 17, 2012

(54) Integrated Electronic Device and Methods of Making the Same

(75) Inventor: Gary R. Tucholski, North Royalton, OH (US)

(73) Assignee: BLUE SPARK TECHNOLOGIES, INC., Westlake, OH (US)

(21) Appl. No.: 12/669,068

(22) PCT Filed: Jul. 30, 2008
(86) PCT No.: PCT/US08/71549

§ 371 Date: Jan. 14, 2010

Related U.S. Application Data
(60) Provisional application No. 60/953,391, filed on Aug. 1, 2007.

(51) Int. Cl. C25B 7/00; H01R 43/00

(52) U.S. Cl. 204/630; 29/825

(57) ABSTRACT

An integrated electronic device, and its method of manufacture, are provided. The integrated electronic device can include Iontophoresis electrodes that are electrically coupled to a thin printed flexible electrochemical cell. In one example, the Iontophoresis electrodes and the electrochemical battery are provided on a single substrate. In one example method of manufacture, the entire cell can be made on a printing press to integrate the battery directly with the electronic assembly of the Iontophoresis electrodes.

### CROSS-REFERENCE TO RELATED APPLICATIONS

This application claims the benefit of U.S. provisional application Ser. No. 60/953,391, filed on Aug. 1, 2007, which is incorporated herein in its entirety by reference thereto.

### BACKGROUND OF THE INVENTION

For the past one hundred years or so, scientists have been making Carbon/Zinc portable power sources for various applications. In the early days of portable power, these power sources were very large compared to today's standards. For example, the very popular “Ignitor Cell” made by Eveready was about 3″ diameter and about 9″ tall and was used in many applications such as radios, buzzers, Xmas lighting, etc. These large cells, as well as some smaller versions, such as the famous Eveready #6 (about 2″ dia.×6″ tall) and the smallest unit cell of the day, the #950 (D size), were commonly made into battery packs with voltages exceeding 40 volts in some applications. These were similar in size, and even larger, than today's car batteries, for uses in lighting devices, radios and car ignition systems. In the mid 1900's, with the advent of advanced electronics such as the transistor, the electrical requirements for portable power sources were drastically reduced. Consequently, cell sizes could also be reduced to include C's, AA's, and AAA's, and even small button cells. This power reduction has continued into the twenty-first century, where applications such as smart labels, smart credit cards, sensors, data loggers, novelty devices such as greeting cards and badges, etc., now require a maximum current of several milliamperes, with many applications requiring as little as a few microamperes at about 1.5-3.0 volts. These applications also have the requirement that the power sources be flat and very thin to maintain their low profiles and portability.

In the past twenty-five years, various approaches for making thin, flat cells and batteries were attempted by numerous scientists and corporations. These include the widely known instant film battery pack developed by Polaroid. This battery pack was used in each package of Polaroid instant film. This allowed Polaroid to have a fresh battery in the camera each time the user placed a new pack of film in the camera. This high cost battery with multiple layers and a metal foil laminate package is a high voltage, high current battery, capable of igniting flash bulbs and powering motors, for example, and is not a realistic competitor of the new thin low cost batteries that are needed. In addition to Polaroid, others have tried to develop thin batteries in various electrochemical systems.

Co-pending U.S. application Ser. Nos. 11/110,202 filed on Apr. 20, 2005 and 11/378,520 filed on Mar. 17, 2006, incorporated herein by reference, discuss new designs and methods of manufacture of a flat cell and battery.

With the growing market needs for low cost, low capacity thin flat cells, it would be beneficial to produce a thin, flat, printable flexible cell that is versatile and inexpensive to mass-produce. Printable, disposable thin cells that are well suited for low-power and high-production volume applications would be useful, especially if they offer adequate voltage, sufficient capacity, and low-cost solutions. Conventional low-profile batteries typically have few of these attributes, if any.

In recent years there has been a growing interest for active skin patches that deliver medication and/or cosmetics by means of Iontophoresis. Initially these patches used large power sources such as generated by household currents or large batteries which meant the patients had to be tethered to these large power sources. However, with the development of lower current devices, the Iontophoresis devices could be powered by smaller and/or portable power sources such as small alkaline cells/batteries and more recently the smaller coin cells could be used. Still, such devices may require expensive hand assembly of cells/batteries with these devises and/or extra hardware to make the connections with the smaller dry cells (alkaline cells and or batteries, and/or coin cells). In addition to the manufacturing problems, the patient may have to contend with a large bulky non flexible patch that probably confined the patient to his or her home. Therefore, a method for allowing manufacturers to integrate the printing of the desired Iontophoresis components while mating components to a battery to power the components would be useful. For example, it would be beneficial to apply both an Iontophoresis device and its power source to a single substrate. In other words, the Iontophoresis device and its power source can share a single substrate to simplify the manufacturing process to provide reduced costs, greater efficiency, and increased economies of scale.

As a result, integrating the printing and assembly of cells and/or batteries with the printing of the Iontophoresis device would also be useful to realize such increased economies of scale. Furthermore, a method of manufacture for integrated devices that would help reduce or eliminate expensive assembly of cells/batteries with these applications would be useful.

### SUMMARY OF THE INVENTION

Provided are a plurality of embodiments for the invention, including, but not limited to, an Iontophoresis device, including: a base substrate having a first side, an Iontophoresis device on the base substrate, and an electrochemical cell and/or battery on the base substrate that is electrically connected to the Iontophoresis device by means of circuitry, wherein the cell or battery is for providing electrical energy for the Iontophoresis process.

In accordance with one aspect of the present invention, a method of manufacturing an Iontophoresis device including a flat electrochemical cell for generating an electrical current is provided. The method including the steps of providing a first substrate and a second substrate. At least one of the first and second substrates includes a plurality of layers. A plurality of electrodes are provided on the first substrate. A cathode layer is provided on the first substrate, and an anode layer is provided on the first substrate. An electrolyte layer is provided including a viscous liquid in contact with the cathode layer and also in contact with the anode layer. A frame is provided on the first side of the first substrate to form an inner space containing the electrolyte, and also containing at least a major portion of the cathode layer and at least a major portion of the anode layer within the inner space. The cathode layer, anode layer, and the plurality of electrodes are electrically coupled, and the second substrate is connected to the first substrate to substantially seal the inner space containing the cathode layer, the anode layer, and the electrolyte layer.

In accordance with another aspect of the present invention, a method of manufacturing an Iontophoresis device including a flat electrochemical cell for generating an electrical current is provided. The method includes the steps of providing a first substrate and a second substrate. At least one of the first and second substrates includes a web having a plurality of layers. A plurality of electrodes are provided on the first substrate. A cathode collector layer is printed on the first substrate. A cathode layer is printed on the first substrate and includes hydroxyethyl cellulose, and an anode layer is laminated on the first substrate. An electrolyte layer is provided including a viscous liquid in contact with the cathode layer and also in contact with the anode layer. A paper separator is provided over each of the anode layer and cathode layer and is adapted to absorb at least a portion of the electrolyte layer. A frame is provided on the first side of the first substrate to form an inner space containing the electrolyte, and also containing at least a major portion of the cathode layer and at least a major portion of the anode layer within the inner space. The cathode layer via the cathode collector layer, the anode layer, and the plurality of electrodes are electrically coupled, and the second substrate is connected to the first substrate to substantially seal the inner space containing the cathode layer, the anode layer, and the electrolyte layer.

In accordance with yet another aspect of the present invention, an Iontophoresis device is provided including a flat electrochemical cell for generating an electrical current. The Iontophoresis device includes a first substrate including of a plurality of laminated layers, and a second substrate. A cathode layer is provided on the first substrate, and an anode layer is provided on the first substrate. A plurality of electrodes are provided on the first substrate and are spaced a distance from the cathode layer and the anode layer. An electrolyte layer includes a viscous liquid in contact with the cathode layer and also in contact with the anode layer. A frame is interposed between the first and second substrate to connect and seal the first substrate to the second substrate to form an inner space containing the electrolyte, and also containing at least a major portion of the cathode layer and at least a major portion of the anode layer within the inner space. At least one of the anode layer and the cathode layer include a cured or dried ink. An electrical coupler assembly provides electrical communication between the cathode layer, the anode layer, and the plurality of electrodes.

In accordance with still yet another aspect of the present invention, a method of manufacturing an Iontophoresis device including a flat electrochemical cell for generating an electrical current is provided. The method includes the steps of providing a first substrate, providing a plurality of Iontophoresis electrodes on said first substrate, providing a cathode collector layer on said first substrate, providing a cathode layer on said first substrate, and providing an anode layer on said first substrate. The method further includes the steps of providing an electrolyte layer in contact with said cathode layer and also in contact with said anode layer, and electrically coupling the cathode layer via the cathode collector layer, the anode layer, and the plurality of Iontophoresis electrodes by a printed, conductive ink.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 illustrates a flow diagram of one example method of manufacturing the example Iontophoresis device;

FIG. 2 illustrates a partial sectional view of the first substrate;

FIG. 3 illustrates a partial sectional view of an example spacer;

FIG. 4 illustrates a partial sectional view of an example anode layer;

FIG. 5 illustrates a top view of an example spacer web;

FIG. 6 illustrates a plurality of example steps of the method of FIG. 1;

FIG. 7 illustrates another plurality of example steps of the method of FIG. 1;

FIG. 8 illustrates another plurality of example steps of the method of FIG. 1;

FIG. 9 illustrates another plurality of example steps of the method of FIG. 1;

FIG. 10 illustrates still another plurality of example steps of the method of FIG. 1;

FIG. 11 illustrates still yet another plurality of example steps of the method of FIG. 1;

FIG. 12 illustrates a top view of an example foam web

FIG. 12A illustrates a sectional view along line 12A-12A of FIG. 12;

FIG. 13 illustrates another plurality of example steps of the method of FIG. 1 utilizing the foam web of FIG. 12;

FIG. 13A illustrates a sectional view along line 13A-13A of FIG. 13;

FIG. 13B illustrates an alternative sectional view along line 13A-13A of FIG. 13;

FIG. 14 illustrates still another plurality of example steps of the method of FIG. 1;

FIG. 15 illustrates still yet another plurality of example steps of the method of FIG. 1;

FIG. 16 illustrates an example roll of Iontophoresis devices; and

FIG. 17 illustrates a schematic view of an example manufacturing process utilizing a generally continuous web.

### DETAILED DESCRIPTION OF THE PREFERRED EMBODIMENTS OF THE INVENTION

Generally, the invention is an electronic device and method of manufacturing said electronic device by integrating an electrical circuit, skin patch electrodes with one or more cells/batteries to power the device. In one example, the method applies both an electronic device and its power source to a single substrate. In other words, the electronic device and its power source can share a single substrate or even two substrates could be laminated to together to simplify the manufacturing process to provide reduced costs, greater efficiency, and increased economies of scale. The circuit and a battery are typically printed and/or laminated on a continuous, flexible substrate web, and may be formed into a roll or the like. The individual devices can be removed from the roll, such as one at a time. For example, the devices can be cut from the roll, and/or perforations of the flexible substrate roll can be provided for easy tear off. The apparatus can include one or more electrical components, such as electrodes and/or control circuitry, for example. The multiple facets of this invention could be used in the total package described and/or they could be used individually or in any combination.

As used herein, unless otherwise explicitly indicated, all percentages are percentages by weight. Also, as used herein, when a range such as “5-25” (or “about 5-25”) is given, this means, for at least one embodiment, at least about 5 and, separately and independently, not more than about 25, and unless otherwise indicated, ranges are not to be strictly construed, but are given as acceptable examples. Also herein, a parenthetical range following a listed or preferred value indicates a broader range for that value according to additional embodiments of the invention.

The present invention relates to thin, printed electrochemical cells and/or batteries comprising a plurality of such cells. Such cells each typically include at least a first electrode including a first electrochemical layer (e.g., a cathode), a second electrode including a second electrochemical layer (e.g., an anode), and an electrolyte that interacts with the electrodes to create an electrical current. All of the first and second electrodes and the electrolyte are typically contained within some structure which provides an external electrical access to the electrodes for providing an electrical current supply to some device.

One method of mass-producing such cells includes depositing aqueous and/or non-aqueous solvent inks and/or other coatings in a pattern on a special substrate, such as a laminated polymeric film layer, for example. The depositing can be by means of, for example, printing conductive and/or electrochemical inks and/or laminating a metallic foil, such as a zinc foil, for example, on one or more high-speed web printing presses with rotary screen and/or flexographic printing stations, especially if the desired volumes are very high. If volumes are relatively lower, say in the quantities of only about several million or less, then relatively slower methods such as web printing with flat bed screens could be appropriate. If the volumes are even lower, such as hundreds or thousands, then a sheet-fed flat bed printing press may be utilized, for example. Still, various printing methods can be used for various desired quantities.

After the inks are printed and/or the solids have been properly placed, the cells can be completed (e.g., sealed, die cut, stacked and/or perforated and wound into a roll, or stacked if sheets are used on a printing press). This cell manufacturing process can also be utilized for integrating one or more individual cells with an actual electronic application, or into batteries comprising multiple cells connected in series or parallel, or some combination of the two. Examples of such devices and corresponding processes will be described later, but many additional embodiments are also contemplated.

As discussed above, the invention may be described as a printed, flexible, and thin electrochemical cell integrated with an electronic device. Such a cell can include, for example, a lower film substrate that can utilize a special polymer laminate that has special features, possibly including, for example, a high moisture barrier layer in the center that is surrounded by polymer films on both sides. Furthermore, one or both outside surfaces can be made to be print receptive for printing information, logos, instructions, identifications, serial numbers, graphics, or other information or images, as desired.

Depending on which construction of this invention is used, the inner ply of the substrate could also feature a heat-sealing layer that might be co-extruded on the side opposite the barrier coating.

In addition, a portion of the inner surface of a lower substrate layer of a cell of at least some embodiments could utilize a cathode current collector, such as carbon, for example, printed or coated or otherwise applied on a portion of the film substrate. At an outside contact area of this collector can also be printed a layer of a relatively highly conductive ink, such as silver, nickel, or tin, for example, to improve the conductivity to the application connection, if desired. However, if the battery application is used for relatively low current requirements, then the higher conductive layer material, or even the current collector, may not be utilized for one or both electrodes.

For at least some embodiments, a water-based ink electrochemical layer is printed as the cathode. Such a cathode layer can include, for example, manganese dioxide (MnO₂), carbon, and a polymer binder. Other formulations for the cathode layer can also be utilized with or without any of these materials. If a cathode collector layer is used, which may or may not form a portion of the cathode layer, the cathode electrochemical layer will be printed on at least a portion of the cathode current collector, which is printed or otherwise applied first to the substrate.

In some embodiments, adjacent to the cathode collector, at a spacing of about 0.050″, can be placed a narrow strip of zinc foil as the anode. Other anode compositions are also possible, such as an ink layer including zinc or some other proper material, for example.

Prior to this anode placement, in an off-line operation, a dry-film adhesive layer, possibly using a release liner, can be applied to the zinc foil. The zinc foil can then be laminated to the base substrate.

Optionally, printed over one or both the anode and cathode, is a starch ink or similar material. The starch ink can act as an electrolyte absorber to keep the electrodes “wet” after an aqueous electrolyte solution is added to the cell. This starch ink could also include the electrolyte salts and the water used for the cell reaction. A paper layer over the anode and cathode could be used in place of the printed starch.

For some embodiments, before or after the two electrodes are in place, with or without the starch layer(s), a cell “picture frame” can be added. This could be done using a number of different methods. One method is to print this cell picture frame with a dielectric ink, for example. Another method is to utilize a polymer sheet or a laminated polymer sheet that includes adhesive layers, that is stamped, die cut, laser cut or similar methods to form the appropriate “pockets” (inner space or spaces) to house materials of each unit cell.

To ensure good sealing of the picture frame to the substrates, and to provide good sealing of the contact feed-throughs (providing an electrical pathway from the cell inside to the cell exterior), a sealing or caulking adhesive could be printed on the substrate and on top of the zinc foil and cathode collector, such as in the same pattern as the cell frame, for example, prior to the frame being printed or prior to the polymer sheets being inserted, for example.

This sealing or caulking material could be pressure sensitive, and/or heat sensitive, for example, such as Acheson Colloids' PM040, for example, or any other type of material that would facilitate sealing to both surfaces.

After the dielectric picture frame is printed and dried and/or cured, a heat sensitive sealing adhesive can be printed on top of the frame to allow good sealing of the top substrate to the cell frame. This cell picture frame could also comprise a polymer film or a laminated film of about 0.015″ thick (range of about 0.003″-0.050″) that is pre-punched and then laminated in registration to match the preprinted caulking adhesive layer described above.

Zinc chloride (ZnCl₂) can be chosen as the electrolyte, for at least some embodiments, in the concentration range of about 18%-45% by weight, for example. In one example, about 27% may be preferred. The electrolyte can be added, for example, to the open cell. To facilitate processing on the line, this electrolyte, or a different electrolyte, could be thickened with, for example, CMC at about a level of about 0.6 wgt % (range of about 0.05%-1.0%).

Other useful electrolyte formulations, such as ammonium chloride (NH₄Cl), mixtures of zinc chloride (ZnCl₂) and ammonium chloride (NH₄Cl), zinc acetate (Zn(C₂H₂O₂)), zinc bromide (ZnBr₂), zinc fluoride (ZnF₂), zinc tartrate (ZnC₄H₄O₆.H₂O), zinc per-chlorate Zn(ClO₄)₂.6H₂O), potassium hydroxide, sodium hydroxide, or organics, for example, could also be used.

Zinc chloride may be the electrolyte of choice, providing excellent electrical performance for ordinary environmental conditions normally encountered. Likewise, any of the above mentioned alternative electrolytes, among others, could be used in concentrations (by weight), for example, within the range of about 18%-45%, with the range of about 25%-35% used for at least some other embodiments. Such compositions could also provide acceptable performance under ordinary environmental conditions.

The use of electrolytes other than of zinc chloride can provide improved cell/battery electrical performance under some differing environmental conditions. For example, about 32% by weight zinc acetate (F.P.—freezing point—about 28° C.) exhibits a lower freezing point than about 32% by weight zinc chloride (F.P. about −23° C.). Both of these solutions exhibit a lower freezing point than of about 27% zinc chloride (F.P. about −18° C.). Other zinc acetate concentrations, e.g. about 18-45 or about 25-35 weight percent, also exhibit reduced freezing points.

Use of such electrolyte formulations as substitutes for zinc chloride, or in various mixtures used in cells, can allow for improved performance at low temperatures. For example, it has been found that the use of an about 32% zinc acetate electrolyte substantially improves low temperature (i.e. below about −20° C.) performance of a voltaic cell. This type of electrochemical cell performance improvement at low temperature can be utilized in various transient (transportable) electrically operated devices, such as Iontophoresis, for example, which may be used, stored, and/or transported in relatively cold environments. For example, many products that are shipped today, such as food products pharmaceuticals, blood, etc, may require low temperature storage and shipping conditions, or even low temperature operation. These devices might require electrochemical cells and/or batteries to operate effectively at temperatures at, or even below, −20° C., such as at about −23° C., about −27° C., or even at about −30° C. or less.

When zinc acetate is used to achieve improved low temperature performance for low temperature applications, the zinc acetate concentration in the range of about 31-33, is often acceptable, although ranges of about 30-34, about 28-36, about 26-38, and even about 25-40, weight percent, could also be utilized.

In at least one embodiment, the construction of the printed starch layer with the addition of the aqueous electrolyte could be replaced, for example, by a printable viscous liquid (which could include a gel, or some other viscous material) that effectively covers at least a portion of each electrode. One such printable gel is described in United States Patent Publication 2003/0165744A1, published on Sep. 4, 2003, and incorporated herein by reference. These viscous formulations could, for example, utilize the electrolyte formulas and concentrations previously discussed.

The upper substrate of a cell package could utilize a special laminated polymeric film, which has an edge that extends beyond the internal cell/battery components onto the cell frame. The upper layer is sealed around the edges of the cell frame by means of a pressure sensitive adhesive (PSA), and/or with the heat sensitive sealing adhesive that was previously printed, thus confining the internal components within the cell frame.

The above-described constructions can be wet cell constructions; however, using a similar cell construction, the present invention could be also be made into a reserve cell construction, which has the benefit of providing extended shelf life prior to the application of a liquid. The printable, flexible, zinc chloride thin cell can be made environmentally friendly. Such a construction could be utilized which does not require the use of harmful components, such as mercury or cadmium, for example. Old and/or depleted cells of this design could thus be disposed using regular waste removal procedures.

The devices for which this technology can be used are extensive. Devices that utilize relatively low power or a limited life of one to three years, and possibly longer, could function utilizing a thin cell/battery according to the invention. The cell of the invention, as explained in the above paragraphs and below, can often be inexpensively mass-produced so that it can be used in a disposable product, for example. The low cost allows for applications that previously were not cost effective.

The electrochemical cell/battery according to the invention might have one or more of the following advantages:
Relatively thin;
Flat, and of relatively uniform thickness, where the edges are of about the same thickness as the center;
Flexible;
Many geometric shapes are possible;
Sealed container;
Simple construction;
Designed for high speed and high volume production;
Low cost;
Reliable performance at many temperatures;
Good low temperature performance;
Disposable and environmentally friendly;
Both cell contacts provided on the same surface;
Ease of assembly into an application; and
Capable of being easily integrated in a continuous process at the same time that the electronic application is being made.

The above was a general description of various cell constructions according to some embodiments of the invention, and further details utilizing drawings follow below. Cell and battery production processes for cell printing and assembly also will be described as well.

Generally, Iontophoresis is related generally to the transdermal delivery of therapeutic agents by the use of an applied electro motive force (emf). The therapeutic agents can include various compounds, such as medication and/or cosmetics, or the like. The process of iontophoresis was described by LeDuc in 1908 and has since found commercial use in the delivery of ionically charged therapeutic agent molecules such as pilocarpine, lidocaine and dexamethasone, though various other therapeutic agents may also be used. In this delivery method, ions bearing a positive charge are driven across the skin at the site of an electrolytic electrical system anode, while ions bearing a negative charge are driven across the skin at the site of an electrolytic system cathode. An Iontophoresis device may include a therapeutic agent, a power source, and electrodes for delivering the therapeutic agent to a patient via the electro-motive force provided by the power source. However, an Iontophoresis device can also include additional elements (analog and/or digital) to provide various additional features, such as control circuitry, computational circuitry, storage circuitry (memory), switches, wired or wireless communication, etc. In other examples, an Iontophoresis device can be remotely controlled, such as by wireless radio frequency transmissions received by an antenna or the like, and may even be capable of transmitting information.

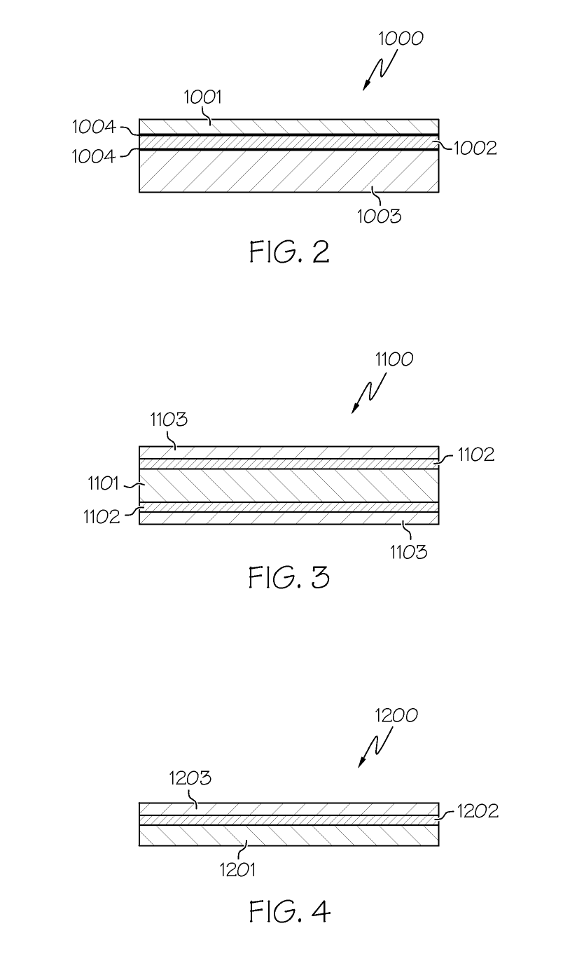

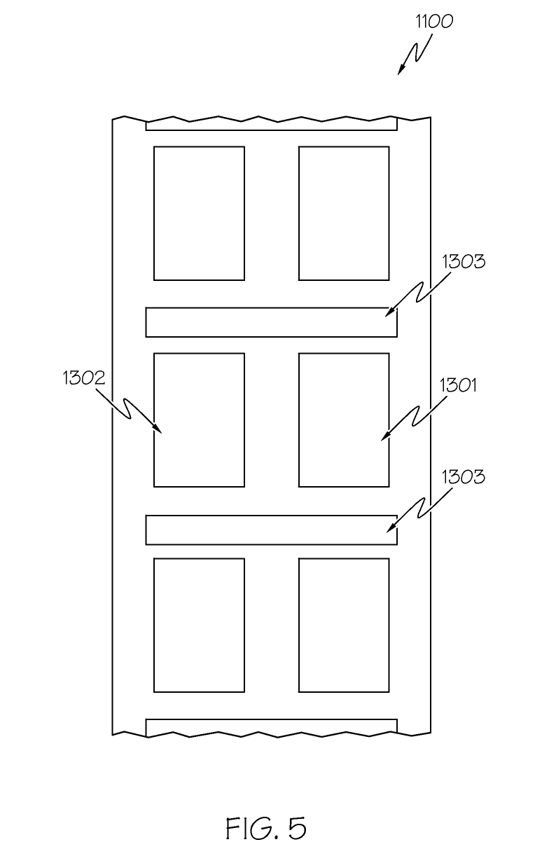

Prior to discussing an example method of manufacturing the Iontophoresis device, various components for use in the manufacturing process will be discussed in greater detail. Turning now to FIG. 2, a partial sectional view of first substrate 1000 is illustrated. The first substrate 1000 can include various layers, such as five layers. For example, the various layers of first substrate 1000 can include three plies of film, and two layers of a UV cured urethane laminating adhesive 1004 which can be relatively thin, such as about 0.2 mils thick, with a range of about 0.1-0.5 mils. In one example, this laminated structure can be supplied by Curwood Inc., a Bemis Corporation Company of Oshkosh, Wis. The top film layer 1001 can be a heat sealable layer, such as provided by DuPont (OL series), on the inside of the cell and can have an example thickness of about 0.00048″ thick (e.g., about 0.0002″-0.002″). The middle film layer 1002 can be a high moisture barrier polymer layer such as the GL films supplied by Toppan of Japan. Typically, this polyester film can have an oxide or metalized coating on the inside of the laminated structure. This coating could have varying moisture transmission values depending on the type and the amount of vacuum deposited oxides, or metals. The third film layer 1003, can be a polyester layer 1003 that can act as a structural layer. This structural layer 1003 of the five ply layer structure of FIG. 5 can be orientated polyester (OPET) and have a thickness of about 0.002″ (e.g., about 0.0005″-0.010″), which can also be laminated to the other layers by means of a urethane adhesive 1004 that is about 0.1 mil thick, for example. This “structural layer” can be a DuPont polyester orientated (OPET) film such as their Melinex brand, for example. Another material that can be used is from Toyobo Co. Ltd. of Japan, which is polyester based synthetic paper, which is designated as white micro-voided orientated polyester (WMVOPET).

Depending on the cell construction, the cell application, and/or the cell environment, it may be advantageous to have different barrier properties for the substrate. Due to the wide range of available vapor transmission rates available, the barrier layer can be chosen for each specific application and construction, as desired. In some cases, for example where the cell by design has a higher gassing rate short life cycle, it may be appropriate and desirable to use a film with a higher transmission rate to allow for a larger amount of gas to escape, so as to minimize cell bulging. Another example would be an application that is in a hot dry environment such as a desert. In such cases, it may be desirable to have a barrier film with low transmission rates to prevent excessive moisture loss from the batteries.

The use of a thicker substrate, by increasing any or all of the polymer thicknesses, may have some advantages: These may include one or both of the following:
The cells process better on printing press due to the thicker substrate being less temperature sensitive; and
The cell package is stiffer and stronger.

In addition to the above specifications, both the outside and the inside layers could include the addition of a print-receptive surface for the inks. The inside layer is used for the functional inks (such as the collector and/or electrochemical layers) while the outside layer can be used for graphical inks, if desired. Flat cell constructions having a sealed system might utilize a laminated structure that includes metallized films and/or a very thin metal foil or foils as a moisture barrier. Although such structures using a metal layer might have better moisture barrier properties than the constructions used for some of the above described embodiments, it might also have some disadvantages. These may include one or more of the following:
Laminated structures with metal barriers (thin metal foil or a vacuum metallized layer) are likely more expensive;
Laminated structures with metal layers have the possibility of causing internal shorts; and
Laminated structures that include a metal barrier could interfere with the electronics of an application, such as the functionality of a RFID antenna, for example.

The various substrates of FIG. 2 and even layers of other figures, can be comprised of numerous variations of polymeric film, with or without a barrier layer (including metal or other materials), and can utilize either mono-layer or multi-layer films, such as polyesters or polyolefin. Polyester is a good material to utilize because it provides improved strength permitting use of a thinner gauge film and is typically not easily stretched when used on a multi-station printing press. Vinyl, cellophane, and even paper can also be used as the film layers or as one or more of the layers in the laminated constructions. If a very long shelf life is desired, and/or the environmental conditions are extreme, the multi-ply laminates could be modified to include a metallized layer such as obtained by vacuum deposition of aluminum in place of the oxide coating 1104

Alternately, a very thin aluminum foil could be laminated within the structure of the film layer, or even in a different position. Such a modification could reduce already low water loss to practically nil. On the other hand, if the application is for a relatively short shelf life and/or a short operating life, a more expensive barrier layer could be replaced with a less efficient one that would be of a lower cost and still allow the cell to function for the desired lifetime.

In applications where only an extremely short life is desired, the cell package could instead use a film layer of a low cost polymer substrate such as polyester or polyolefin. It is possible that the pressure sensitive adhesives for coupling and/or sealing the various substrates together could be replaced with a heat sealing system on the laminates. For example, a heat sealing coating or the like could be used, such as amorphous polyester (APET or PETG), semi crystalline polyester (CPET), polyvinyl chloride (PVC), or a polyolefin polymer etc. on polymer film such as polyester. One such example material is the Ovenable Lidding (OL) films made by Dupont and designated as their OL series such as OL, OL2 or OL13.

Similar to FIG. 2, FIG. 3 illustrates a partial sectional view of a third substrate 1100 that can be utilized as a spacer frame. The third substrate 1100 can be composed of various materials, such as PVC or PET film 1101 at about 0.002″-0.030″ thick and preferably at about 0-0.005″-0.015″ that is sandwiched between (i.e., interposed between) two layers to a pressure sensitive adhesive (PSA) 1102 that is about 0.003″ thick (0.001″-0.005″) and includes a release liner 1103. In addition or alternatively, as shown, the third substrate 1100 can be configured with double-sided adhesive such that the adhesive layer 1102 is located on both sides of the composite with or without a film layer 1101.

FIG. 4 illustrates a partial sectional view of an example anode assembly 1200, as will be discussed more fully herein. The anode assembly 1200 can include various materials, such as zinc foil 1201 at about 0.0015″-0.005″ thick and preferably at about 0.002″ that is laminated to a pressure sensitive adhesive (PSA) 1202 that is about 0.003″ thick (0.001″-0.005″) and includes release liner 1203.

FIG. 5 is a top view of the third substrate 1100 of FIG. 3 and is shown as a web. The third substrate 1100 can include example cutout cavities 1301 and 1302 that can be utilized for the active materials for unit cells 1501 and 1502, respectively. The third substrate 1100 can also include other cutout cavities 1303, such as for the cell and battery contacts. These contact cavities are optional, however, for this description of this integrated electronic device/battery application the various contact cavities 1303 will not be shown in the various assembly steps for clarity.

An example method of manufacturing the Iontophoresis device will now be discussed. In one example, such as where relatively high speed, high output manufacturing is contemplated, such as 50 linear feet per minute or another relatively high speed, the invention can utilize multiple webs. It is to be understood that the multiple webs can be generally continuous, and can be utilized with known web manufacturing equipment. A first web can be relatively thin, such as ˜0.002″-0.010″ and preferably about 0.003-0.006″, flexible base substrate including a multi-ply laminated structure or single ply material. In one example, the multi-ply structure can include five layers. Alternatively, the single ply material can include various materials, such as Kapton or polyester. A second web can be a relatively thick laminated structure including a PVC or Polyester film that is about 0.005-0.030″ thick, and preferably about 0.010-0.015″ thick. The second web can have a layer of pressure sensitive adhesive at about 1-5 mils thick on one side. After this laminated structure of the second web is completed, it can be applied to the first web. In addition or alternatively, the second web can be pattern cut using any type of mechanical means to allow for cavities for the cells active materials as well as an optional cavity for the cell/battery contacts. A third web can be a relatively thin laminated structure the same and/or similar to the first web. The completed three web structure may have a pressure sensitive adhesive on either side to allow the individual device assembly to be applied as a label. The cell/battery may be of the thin cell type, such as disclosed in co-pending application Ser. No. 11/110,202, filed on Apr. 20, 2005 and incorporated herein by reference, and/or the cells disclosed in co-pending application Ser. No. 11/378,520, filed on Mar. 17, 2006, and also incorporated herein by reference.

The various conductive inks described herein could be based on many types of conductive materials such as carbon, silver, nickel, silver coated copper, copper, silver chloride, zinc and/or mixtures of these. For example, one such material that shows useful properties in terms of conductivity and flexibility is Acheson Colloids (Port Huron, Mich.) PM046. Furthermore, various components of the Iontophoresis device, such as the printed electrodes, circuitry, etc. can be made by etching aluminum, copper or similar type metallic foils that are laminated on a polymer such as Kapton substrate. This could be done with many types (sizes and frequencies) of components whether they are etched or printed. As described herein, a 3 volt battery is obtained by connecting two 1.5 volt unit cells in series, although other voltages and/or currents can be obtained by using unit cells with different voltages and/or by combining different numbers of cells together either in series and/or in parallel. Thus, applications using greater voltages can connect unit cells in series, whereas applications using greater currents can connect unit cells in parallel, and applications using both can utilize various groups of cells connected in series further connected in parallel. Thus, a variety of applications that use different voltages and currents can be supported using a variety of unit cell and/or battery configuration.

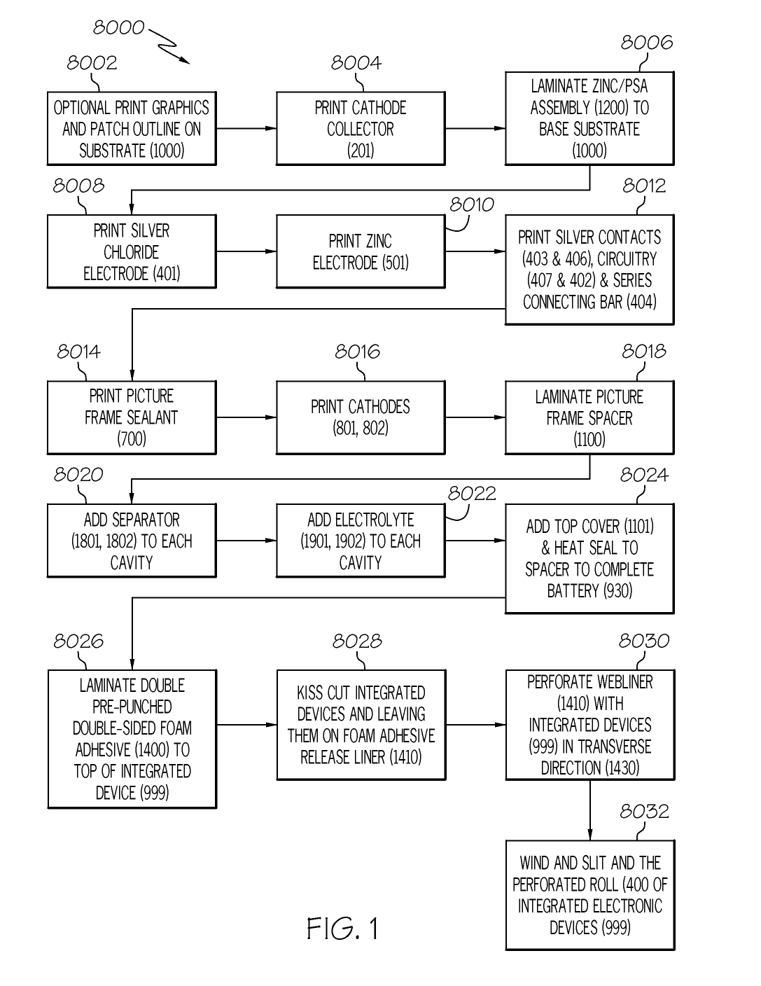

To make the manufacturing process of a cell/battery more efficient and/or achieve greater economies of scale, such as via production at high speeds and low cost, the processing and assembly could be integrated with the manufacture of an electronic component (for example, one to be powered by the battery or cell). In other words, the completed electronic application with the power source can be manufactured at the same time. An example of an integrated procedure is illustrated in the flow diagram of FIG. 1 and is described in the following paragraphs. In this example procedure, the integrated electronic device proceeds through numerous stations that are compatible with a high-speed printing press running a roll-to-roll setup.

According to available printing presses, the cells could be made with one pass, or multiple passes, on a given press, for example. The various drawings illustrate, as an example, two rows of cells to make a 3 volt battery on the web; however, the number of rows is limited only to the size of the unit cells and the maximum web width that the press can process. Because there may be numerous steps, thereby likely utilizing a long and complicated press, some of these steps, as well as some of the materials, could be modified and/or multiple passes of a press or multiple presses could be used. Some modified process summaries will be shown after the initial discussion is completed. Moreover, any or all of the printing steps can be performed by screen printing, such as by flat bed screens or even rotary screen stations. Additionally, one skilled in the art would realize that one printing and converting on a press with more than ten stations could be difficult to find and or to operate, and thus the following discussion of the process could occur on one or more presses or even multiple passes through one press.

However, before the cell/battery is processed as shown in FIG. 1, various optional operations may or may not occur. For example, the optional operations of heat stabilization of the web and/or graphics printing (which could include logos, contact polarities, printing codes and the addition of registration marks on the outside surface of web). If these optional printing operations occur on the web, then the web can be turned over and the functional inks are printed on the inside surface, which may then become an outside laminate (i.e., outside surface).

One skilled in the art would realize that there are many methods, materials, and sequences of operations that could be used to accomplish this invention, and that more or less, similar or different, numbers of stations could also be utilized. For purposes of brevity, the example integrated process 8000 will be discussed with the manufacture of an Iontophoresis device 999 and/or other power-assisted medication dispersal device. Still, it is to be understood that the following process 8000 can also be utilized for the manufacture of various other integrated electronic devices. Further, for the purposes of clarity only one column of devices 999 will be described and illustrated with the understanding that such description can similarly apply to other columns. Moreover, it is to be understood that any or all of the following elements can include any of the various materials, chemical compositions, etc. described throughout this document. Additionally, the various steps as shown in the process 8000 of FIG. 1 are intended to be merely example steps, and it is to be understood that the steps can include various other steps, alternatives, etc. as discussed herein, any or all of which may differ from those example steps shown in FIG. 1.

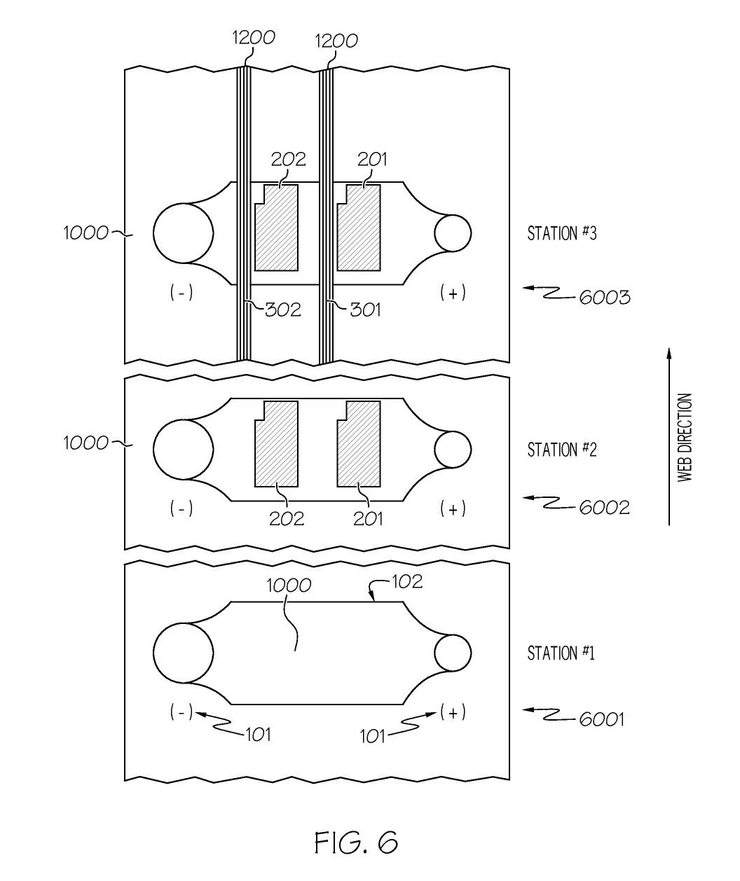

As discussed above, the integrated process 8000 shown in FIG. 1 can begin with or without a heat stabilized first substrate 1000. As will be discussed herein the cells/batteries can be constructed according to the following example process shown in FIGS. 6-17. While the following steps will be discussed with reference to various “stations” that the first substrate 1000 encounters, it is to be understood that these “stations” may or may not involve discrete stations and/or steps, and that any or all of the “stations” and/or steps may be performed by one or more machines, and/or even manually. Moreover, any or all of the various “stations” and/or steps may be combined, and/or even performed simultaneously.

The process 8000 includes the first step 8002 at the first station 6001, which can be optional, of printing various indicia, such as graphics, letters, symbols, etc. on the first substrate 1000. For example, an outline 102 of the Iontophoresis device can be printed. In addition or alternatively, polarity indicators 101, instructions (not shown), or the like can similarly be printed. The indicia can be printed using various materials, such as commercial graphic inks and/or any of the inks described herein.

Next, in step 8004 at the second station 6002, the cathode collector 201 is printed onto the first substrate 1000 with a highly conductive carbon ink. The cathode collectors 201 and 202 can include various materials, such as a highly conductive carbon ink (e.g., PM024) such as manufactured by Acheson Colloids of Port Huron, Mich. The cathode collectors 201 and 202 can be printed on the lower laminate by commercial means such as screen printing, for example using a very coarse screen of about 61 mesh (about 20-100 mesh for some embodiments) to allow for a dry deposit of about 1 mil (about 1.2-0.4 mils respectively). A cell with a size of about 2″×2″ would thus have a resistance of about 60 ohms (about 40-100 ohms). To further reduce this resistance, a highly conductive contact could be printed at the external contact area of the positive electrode. The material used in this example construction is a silver filled conductive ink (SS479) manufactured by Acheson Colloids of Port Huron, Mich. which can be screen printed.

Other useable conductive materials, such as gold, tin, copper, nickel and/or mixtures of two or more conductive materials, along with other materials, could also be used for acceptable embodiments. Any of these conductive inks might be applied by means of, for example, a printing method, such as flat bed screen, rotary screen, flexography, and gravure, as well as with ink jet printing techniques, for example. Additionally, manufactured foils of graphite and/or mixtures including one or more of conductive resins, metals, and graphite could be inserted and used, instead of printing an ink cathode collector. In applications where only very low currents are used, a highly conductive positive contact may not be utilized, and/or if somewhat higher currents are desired, the circuit contact might instead be used as the high conductivity contact.

Next, in step 8006 at the third station 6003, a continuous strip of zinc foil/PSA laminate 1200 (i.e., see FIG. 4) is laminated onto the first substrate 1000. Various materials can be used, such as an assembly comprised of the zinc foil at about 0.002″ thick and PSA film at about 0.003″ thick. A release liner can be removed just prior to laminating laminate 1200 to the first side 1001 of first substrate 1000.

In the example embodiments, strips of zinc foil can be continuous; however, they are illustrated broken off at the edges of the individual stations to better identify the unit stations. In another embodiment (not shown), a precut anode strip foil 301, 302, which can be a laminate (and of possible dimensions of about: 1.75″×0.20″33 0.002″, for example), is inserted onto the lower substrate adjacent to the cathode collector at a gap of about 0.050″ (about 0.010″-0.100″) from the cathode collector. Prior to its lamination for high speed and high volume applications or insertion onto substrate 1000 for lower speed and volume applications, the 2 mil thick battery grade zinc foil can be laminated to a dry film adhesive with a release liner, such as #2180, IB1190 or IB2130 manufactured by Morgan Adhesive Co. of Stow, Ohio. After this lamination is completed, for example on a wide roll of zinc (e.g., about 3-12′ wide), this laminated structure can be slit into narrow rolls with a width of about 0.200″ (about 0.170″-0.230″) for an about 1 sq. inch cathode cell. Cells with other sizes of cathodes can utilize different slit widths for the anode laminate. In another construction, the lamination could be done with a printed adhesive on the substrate prior to applying the zinc foil strip, for example. Still, in other examples, the anode can be provided by a printing process. For example, the anode can be printed about 0.20″ wide and about 0.002″ (about 0.0003-0.005″) thick, though various other widths and thicknesses are contemplated. Moreover, to make the printed anode even more conductive, an anode collector (not shown) can be printed under the anode, such as in a conductive pattern or the like.

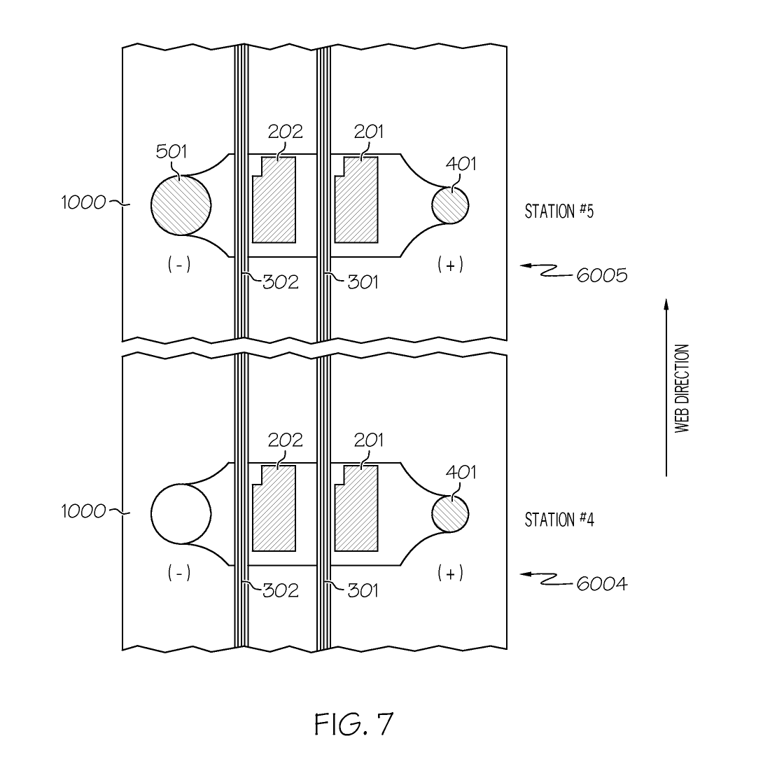

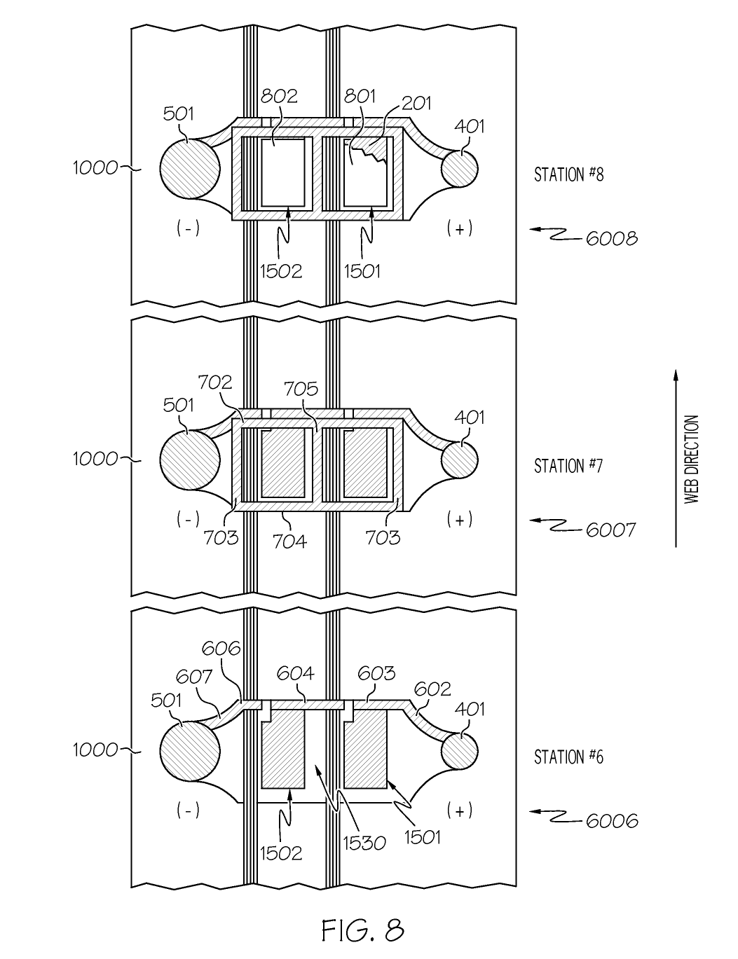

Next, in step 8008 at the fourth station 6004 illustrated in FIG. 7, a first Iontophoresis electrode 401 can be provided onto the first substrate 1000. In one example, the first electrode 401 can be printed onto the first substrate 1000 using various inks, such as a silver chloride ink. Still, various other inks can also be used, such as zinc ink. The first electrode 401 can be a positive electrode (as shown), though it can also be a negative electrode depending upon the construction of the device.

Next, in step 8010 at the fifth station 6005, a second Iontophoresis electrode 501 can be provided onto the first substrate 1000. In one example, the second electrode 501 can be printed onto the first substrate 1000 using various inks, such as zinc or silver chloride ink. Indeed, where both of the first and second electrodes 401, 501 are printed using the same ink, both can be printed generally simultaneously. Still, various other inks can also be used, such as zinc ink. For example, use of one silver chloride electrode and one zinc electrode can facilitate medicine delivery. As before, the second electrode 501 can be a negative electrode (as shown), though it can also be a positive electrode depending upon the construction of the device. Moreover, either or both of the first and second electrodes 401, 501 can have various geometries, such as circular, triangular, square, rectangular, other polygonal shape, random, etc. Either or both of the first and second electrodes 401, 501 can have also have various sizes. For example, the first electrode 401 (i.e., positive) can be generally smaller than the second electrode 501 (i.e., negative) so as to facilitate application of medicated pads having positively charged medication and negatively charged medication, which can have similar size differences.

Next, in step 8012 at the sixth station 6006 illustrated in FIG. 8, a silver battery contact 603 can be printed, along with an extension 602 that allows it to be electrically connect to the patch positive electrode 401 and the positive contact 603 of cell 1501. This can provide the positive contact of the three volt battery 1530. In addition or alternatively, in the same or another station is printed the batteries negative contact 606 and its extension 607 to electrically connect the batteries negative contact to the patch negative electrode 501. This can provide the negative contact of the three volt battery 1530. In addition or alternatively, in the same or another station is printed the series connector bar 604 (i.e., a jumper battery contact) over a portion of the top of cathode collector 202 of the left hand cell 1502 and extended to the top of the anode 301 of the right hand cell 1501. Thus, the two unit cells 1501, 1502 can be connected to create the 3 volt battery 1530. In other words, the silver ink can electrically couple the cathode layer 801, 802, such as via the cathode collector 201, 202, the anode layer 1200, and the plurality of electrodes 401, 501. It is to be understood that any or all of the printed elements described herein can also be provided by lamination. For example, the contacts 603, 604, 606 can be provided as a metallic-flex circuit, on side one of first substrate 1000, thereby eliminating the need to print said contacts. Example metallic-flex circuits can include an aluminum-flex or copper-flex circuit, etched aluminum, etc.

Next, in step 8014 at the seventh station 6007, a frame sealant 700 (i.e., shaded area 702, 703, 704, 705), which can be an adhesive, can be printed around the perimeter of both unit cells 1501 and 1502 to form a “picture frame.” The frame sealant 700 can be provided on top of the zinc anode 1200 and over the cathode collector 201, 202 in the seal area, as well as along a top 702, bottom 704, sides 703, and the centerpost 705. The frame sealant 700 can generally bound an inner space 230 that will define an interior volume of the battery cells 1501, 1502.

The frame sealant 700 can be provided as one frame surrounding both cells of the 3 volt battery package, though it can also be provided as separate elements. Though described as being printed, the frame sealant 700 could also be formed from a pre-punched polymer sheet, such as polyvinyl chloride, polyester, or various other dielectric or electrically-neutral material. Additionally, though shown as having a generally rectangular geometry, the frame sealant 700 can have various other geometries so as to bound the battery cells 1501, 1502. In addition or alternatively, the frame sealant 700 can have an adhesive layer, such as a PSA layer or the like.

Next, in step 8016 at the eighth station 6008, the cathode layer 801, 802 can be screen-printed over part of the cathode collector 201, 202 for both cells 1501 and 1502. In an example embodiment, the cathode layer 801, 802, shown as a partial cut-away for clarity, can be printed on a portion of the previously printed and dried cathode collector layer 201, 202 with an aqueous based ink that has a wet composition, for example, of about 43.4% of battery grade Manganese Dioxide (about 20%-60%), about 14.4% of KS-6 graphite (about 2%-25%), about 29.5% of about 6.5% (about 0.5%-15%) aqueous solution of polyvinylpyrrolidone (PVP) (about 20%-60%); and about 9.65% of De-ionized or distilled water (about 0.1%-20%). Such an ink can be printed with about a 46 mesh (about 10-65 mesh) fiberglass screen so as to allow a nominal dry lay down weight of about 0.10 grams per square inch (about 0.03-0.25 g/sq. in.). The amount of dry print would typically be dictated by the desired cell capacity, using more material when a higher capacity is desired, for example. By using this unconventional printing method utilizing a very coarse mesh screen instead of multiple hits of a finer mesh screen, the number of printing stations can be reduced and the cell performance can be increased. In addition or alternatively, the cathode layer 801, 802 can be printed on a portion of the previously printed and dried cathode collector layer 201, 202 with another aqueous based ink that replaces the above-described polyvinylpyrrolidone (PVP) component with Dow Cellosize hydroxyethyl cellulose (HEC) in about 0.93 to 1.08% (weight percent) solutions in deionized water solutions that represent about 40% (weight percent) of the wet cathode. Various HEC's can be used, such as type HEC-25 or type QP100 MH.

The cathode layer 801, 802 material used in this example construction includes, for example, an electrolytic manganese dioxide of high purity battery grade. The material particle size range for this embodiment is, for example, about 1 to 100 microns with an average size of about 40 microns. If additional fineness of the material is desired to facilitate the application to the collector, the material can be milled to achieve a particle size range of about 1 to 20 microns, with an average of about 4 microns, if desired. Other usable electro-active cathode materials that may be used in conjunction with the zinc anode in the subject construction, are silver oxides Ag₂O and/or AgO, mercuric oxide HgO, nickel oxide NiOOH, oxygen O₂ (as in the form of an air cell, for example), and Vanadium oxide VO₂, for example. Cathodic materials that may be used with different anodic materials include one or more of NiOOH with Cd, NiOOH with metal hydrides of the AB₂ and the AB₃ types, and NiOOH with Fe and FES₂, for example.

A binder used in the cathode layer 801, 802 of an example embodiment includes a class of high molecular weight binders that exceed about 950,000-grams/mole. One such polymer that can be used is polyvinylpyrrolidone, about K 85-95 or about K 120 (higher molecular weight). Other classes of materials that can be used include one or more of the following: polyvinyl alcohol; classes of starches and modified starches, including rice, potato, corn, and bean varieties; ethyl and hydroxy-ethyl celluloses (HEC); methyl celluloses; polyethylene oxides; polyacryamides; as well as mixtures of these materials. Additional binding may be derived, if desired, from the use of Teflon solutions or Teflon fibrillated during the blending process.

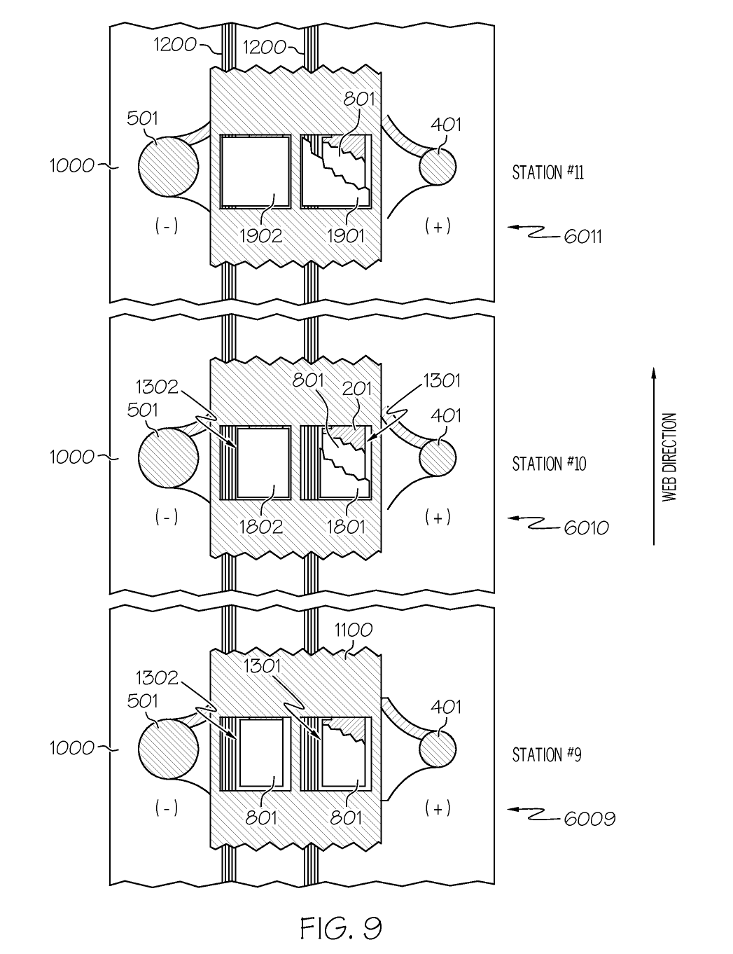

Next, in step 8018 at the ninth station 6009 in FIG. 9, the third substrate web 1100 can be laminated over the first substrate 1000 to provide the frame to form the inner space for the battery cells 1501, 1502. It is to be understood that the third substrate web 1100 can be used together with, or independent of, the aforedescribed frame sealant 700. Generally, the third substrate web 1100 can be utilized as a spacer as it is generally relatively thicker than the frame sealant 700. The third substrate web 1100 can be laminated over the first substrate 1000 with the picture frame cutouts 1301 and 1302 around the active ingredients of the cells 1501, 1502. In addition or alternatively, various other cutouts (not shown) can be located for the cells and battery contact areas onto the first substrate 1000, such as to facilitate the electrical coupling of the cells 1501, 1502 with other components, such as various “off-board” components. However, where no “off-board” components are intended, the third substrate web 1100 may not include the other cutouts. The adhesive layer 1102 (see FIG. 3) of the third substrate web 1100 can be applied onto the first side 1001 of the first substrate 1000 after the release liner 1103 is removed. Further, though illustrated as a web, the third substrate 1100 can also be provided as discrete elements, such as discrete sheets or the like.

Next, in step 8020 at the tenth station 6010, “paper separator” 1801, 1802 or another type of soak-up material can be inserted on top of the anode and the cathode. Alternatively, a “starch ink” or the electrolyte could be flowed or printed over the anode and cathode that are inside the picture frame.

Next, in step 8022 at the eleventh station 6011, when a paper separator 1801, 1802 is used, an electrolyte 1901, 1902, such as an aqueous ZnCl2 electrolyte, is added to the top of the paper separator 1801, 1802 which was placed over the cathode 801, 802 and anode 1200. In addition or alternatively, a starch ink or similar material could be used to act as an electrolyte absorber to keep the electrodes “wet” after an aqueous electrolyte solution is added to the cell. This starch ink could also include the electrolyte salts and the water used for the cell reaction.

As an alternative to the aforedescribed eleventh station 6011, an alternative electrolyte configuration (not shown) can be used when a paper separator is not used. For example, the electrolyte can be provided in the form of a viscous liquid (such as a flowable-gel) is added on the inside area of each unit cell. Due to its flow-ability, the electrolyte will generally spread out to uniformly to cover the anode and cathode. A printed electrolyte (e.g., using an ink or flowable gel) could be substituted for the liquid electrolyte and paper separator of the above referenced application.

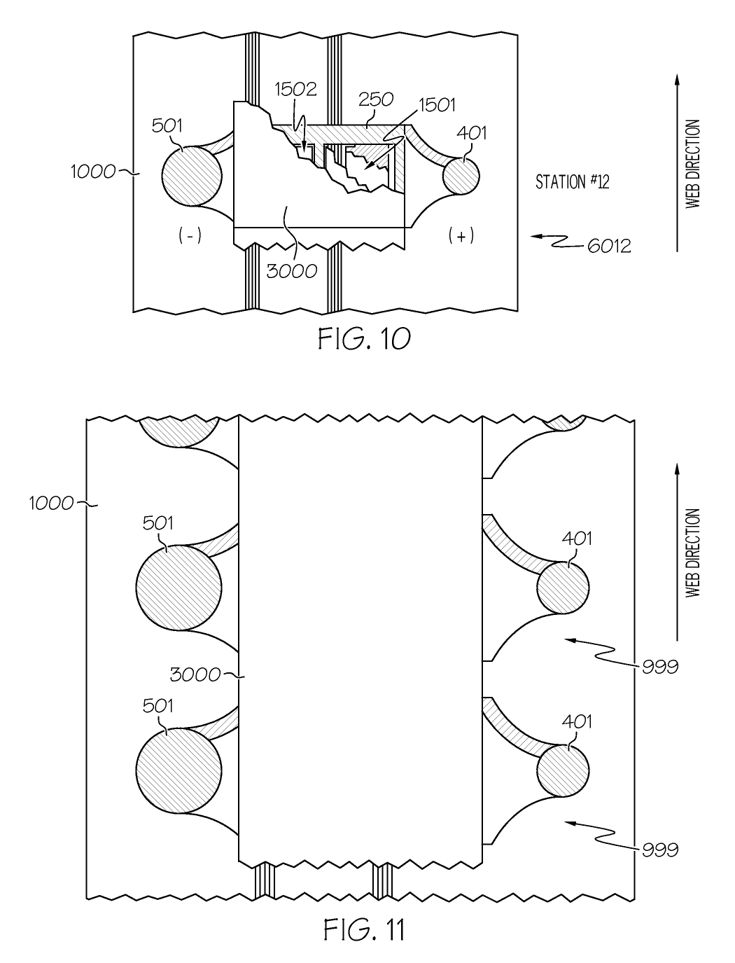

Next, in step 8024 at the twelfth station 6012 in FIG. 10, the second substrate 3000 is added as a “top cover” to the top of the picture frame (i.e., the third substrate 1100). Thus, the second substrate 3000 generally seals the battery cells 1501, 1502. The seal of the second substrate 3000 can be provided by a layer of pressure sensitive adhesive 1102 on the spacer web 1100 and/or a heat seal layer on the bottom side of second substrate 3000, such as a double-sided adhesive configuration previously discussed with reference to FIG. 6. The battery cells 1501, 1502 are completely sealed around their perimeter after pressure and/or heat is applied to form the battery seal 250. For clarity, the unit cells 1501, 1502 are visible due to the cut-away view of the top cover 3000. Moreover, as shown, the second substrate 3000 “top cover” can be provided with a width sufficient to cover and seal the unit cells, while also keeping the first and second electrodes 401, 501 generally uncovered. However, it is to be understood that the second substrate 3000 can also be provided with apertures (not shown), such as holes, that correspond to the electrodes 401, 501 such that the electrodes 401, 501 are exposed therethrough. For ease of explanation and clarity, the twelfth station 6012 is illustrated in FIG. 11 with a plurality of Iontophoresis devices 999 manufactured on the generally continuous web of first substrate 1000 having the generally continuous web of second substrate 3000 coupled thereto.

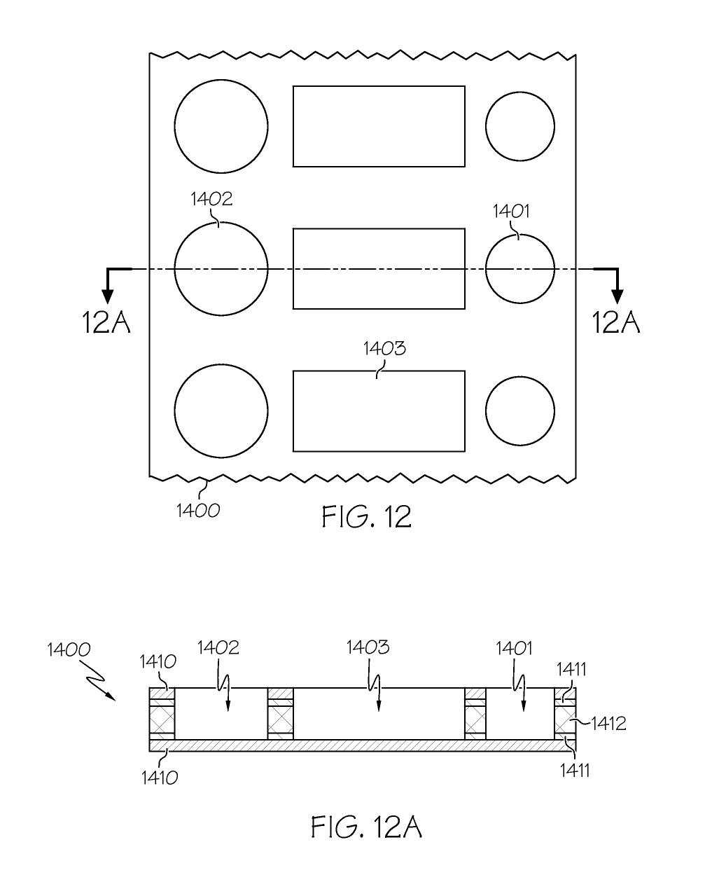

Turning now to FIG. 12, an example fourth substrate 1400 is illustrated for use with the example manufacturing process discussed herein. Specifically, the Iontophoresis devices 999 provided through the twelfth station 6012 in FIGS. 10-11 can be relatively thin. However, the medicated pads containing the electrically charged medicine can be relatively thicker. As a result, it can be beneficial to provide a relatively thick fourth substrate 1400 to increase the thickness of the Iontophoresis devices 999 provided through the twelfth station 6012 in FIGS. 10-11 to accommodate the medicated pads.

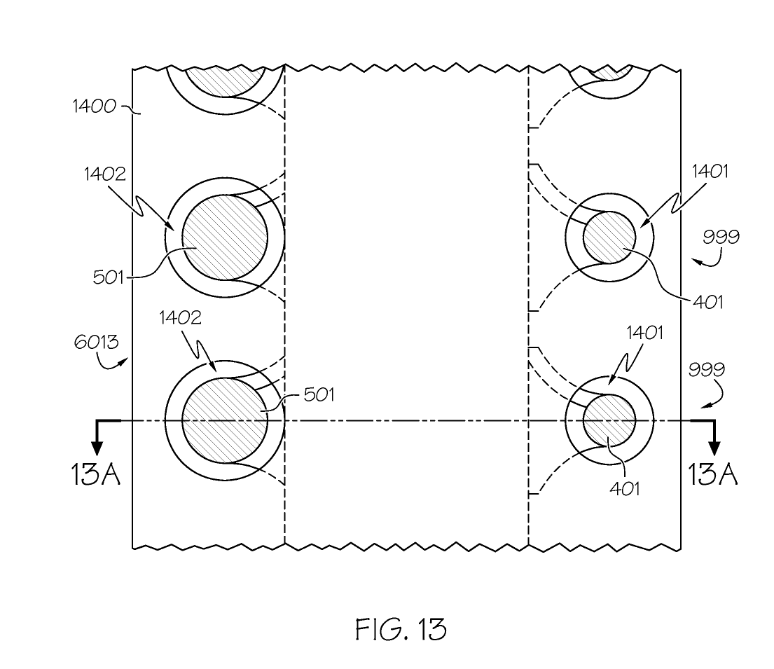

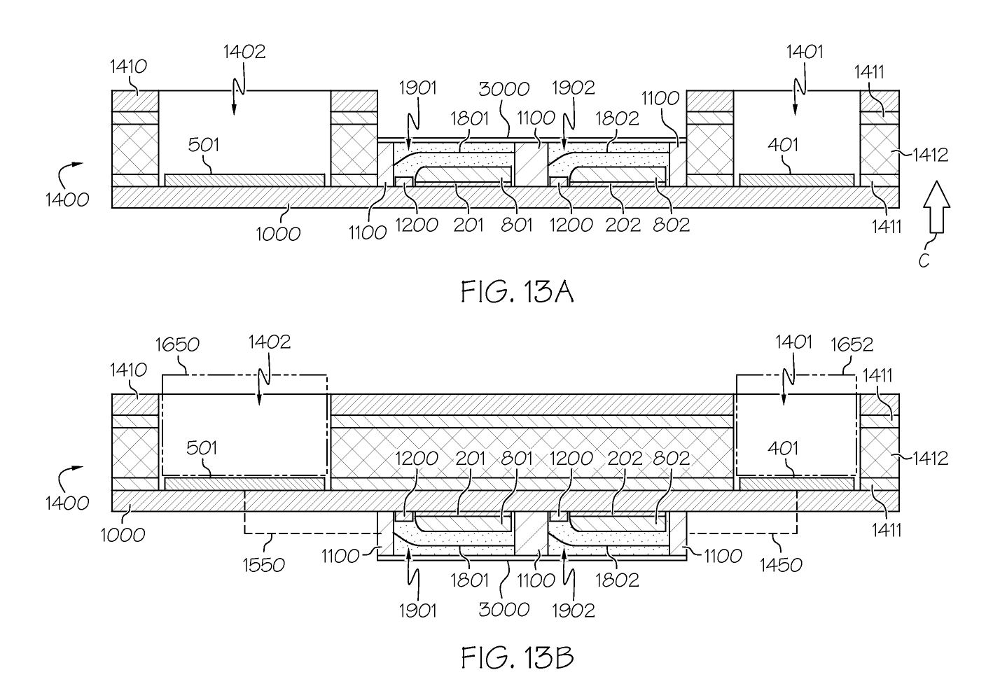

In one example, as shown in FIG. 12, the fourth substrate 1400 can be provided as a generally continuous foam web material, such as a medical foam or the like suitable for application to the skin of a user, though various generally flexible and compressive materials can be utilized. As shown in FIG. 12A, the fourth substrate 1400 can include various layers, such as five layers. For example, the fourth substrate can include a central foam layer 1412 interposed between adhesive layers 1411 (such as a pressure-sensitive adhesive) each having a release film layer 1410. Still, various other layers can also be included. Moreover, the fourth substrate 1400 can include one or more cavities 1401, 1402, and 1403 extending at least partially through the various layers. For example, the cavities 1401, 1402, 1403 can extend through all of the layers or all of the layers except for one of the release film layers 1410, though various other depths are also contemplated. The cavities 1401, 1402, 1403 can also have various geometries and/or sizes. For example, as shown, each of the cavities 1401, 1402 can have a geometry and size that generally corresponds to the first and second electrodes 401, 501, respectively. Thus, the cavities 1401, 1402 can be spaced a distance apart corresponding to the relative spacing of the electrodes 401, 501, and the second cavity 1402 can be relatively larger than the first cavity 1401. Cavity 1403 as shown in cross section drawing of FIG. 13A is a cutout for the 3 volt battery 1530, thus its size and shape can be slightly larger than the battery size to allow for easy lamination of the webs 1400, 1000, and 3000.

Turning now to FIG. 13, in step 8026 at the thirteenth station 6013, the fourth substrate 1400 is laminated over the assembly of the first and third substrate layers 1000, 3000. The fourth substrate 1400 is oriented such that each of the cavities 1401, 1402, and 1403 are located over the corresponding first and second electrodes 401, 501 as well as battery 1530. In other words, the first and second electrodes 401, 501 are exposed through the cavities 1401, 1402 and a pocket is created for battery 1530 as shown in FIG. 13A. Moreover, though the fourth substrate 1400 is illustrated as extending generally full width of the first substrate 1000, the fourth substrate 1400 can also have various other widths.

Another possible embodiment of the invention is illustrated in FIG. 13B as an alternative to FIG. 13A. In this embodiment cavity 1403 is eliminated, which can allow for relatively more adhesive to attach to the body of a patient. Similar process steps as discussed herein can still be utilized with some modifications. For example, the patch electrodes 401 and 501 and the connecting circuitry for the power source could be printed on the other side of substrate 1100. The power source 1530 then would have to be connected to the patch circuitry by means of the previously discussed through holes, vias, electrical jumpers, etc. that are schematically illustrated by lines 1450 and 1550. This embodiment may be beneficial in providing relatively more adhesive that would be available for attaching to the patient's body, thus a more reliable attachment. Also, the patch part of this device could be relatively flatter with the power source battery 1530 located above the patch thus making the patch relatively more flexible.

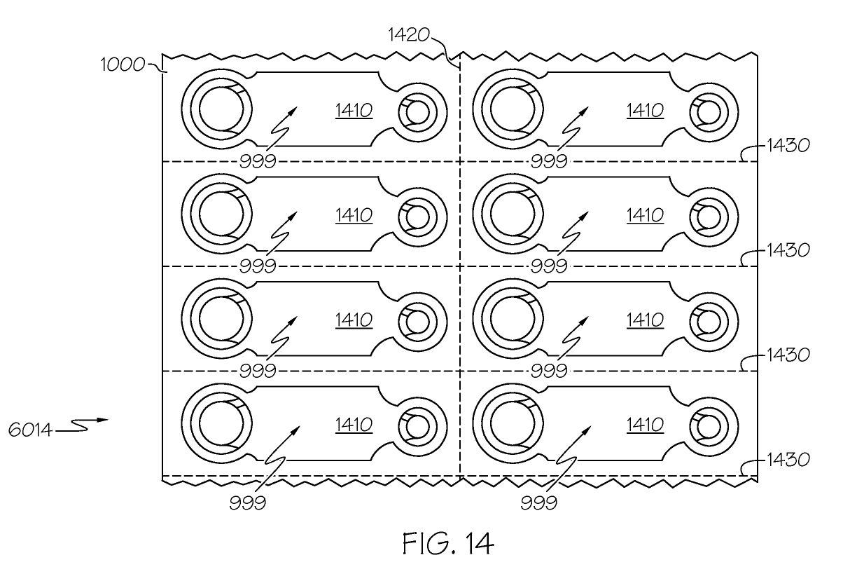

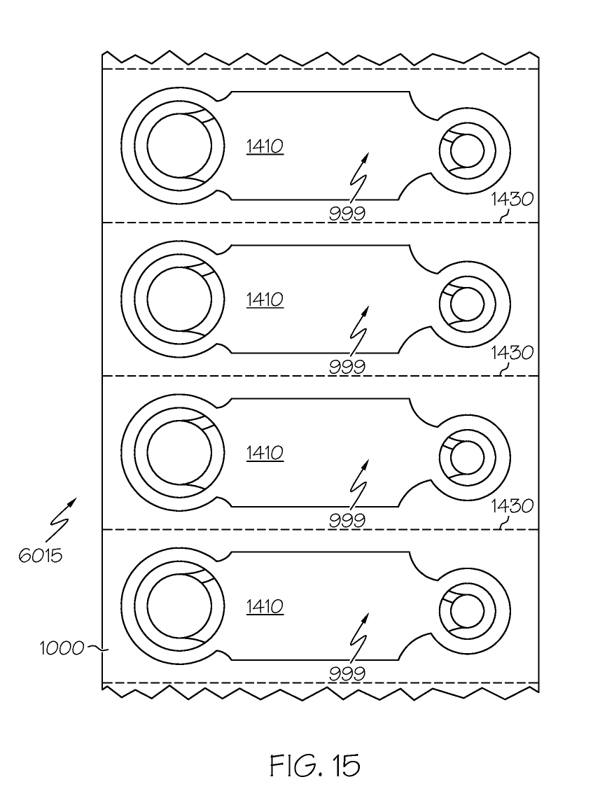

Turning now to FIG. 14, for the purpose of further discussion and illustration the web is shown to have two rows of devices 999 and it is to be understood there could be many rows depending on the web width of the printing presses used in the process. In step 8028 at the fourteenth station 6014, the integrated electronic device 999 with the three volt battery can be perforated or even slit in the longitudinal direction along line 1420 and/or perforated in the tranverse direction along a line 1430 extending across the width of the web. The perforations and/or slits can facilitate separation of the Iontophoresis devices 999 from each other. In addition or alternatively, the integrated electronic device 999 with the three volt battery can be slit in the longitudinal direction along a line 1420 to actually separate the web into two columns or rolls (i.e., see FIG. 15) that can be separately packaged, post-processed, etc. Either or both of the slits and the perforations can be performed using various methods, such as a rotary die or the like.

Also in step 8028 (or even in step 8030 below), the fourth layer 1400 (i.e., the foam web) of the Iontophoresis devices 999 can be “kiss cut” to define a shaped element, such as a desired shape of the devices 999. It can be beneficial to perform the “kiss cut” operation(s) prior to the above-described perforating and/or slitting operations, though either operation can precede the other. It is to be understood that the “kiss cut” can provide various shapes of the Iontophoresis devices 999. As used herein, the phrase “kiss cut” is intended to generally refer to a separation by a cut (i.e., provided by a knife cut, a linear die cut, a rotary die cut, etc.) through at least a face material (though can also be through various layers) without removing a matrix between remaining layers. In other words, a “kiss-cut” is a controlled depth cut that extends only through a predetermined number of layers. For example, in the shown example only the bottom release liner is not cut, though various numbers of layers can be cut. Thus, as shown in FIG. 13A, the assembled Iontophoresis devices 999 can be “kiss cut” in the direction of arrow C through the first substrate 1000 and successively through layers 1411, 1412, and 1411, leaving only the top release layer 1410 intact. As a result, the a desired shape of the devices 999 is provided and left on the release liner 1410, thus providing a carrier for the devices 999, while the un-needed outside matrix (i.e., a waste matrix) of the fourth layer 1400 is stripped away therefrom. Still, it is to be understood that the “kiss cut” can extend through various layers. In one example, the “kiss cut” can be controlled to extend through any or all of the layers 1000, 1411, 1412, 1411, and/or even layer 1410 if an additional carrier is provided. The “kiss cut” operation can provide devices 999 as shown in FIGS. 14 and 15. It is to be understood that the alternative, assembled Iontophoresis devices 999 shown in FIG. 13B can similarly be “kiss cut” in a similar direction as the arrow C of FIG. 13A. The “kiss cut” can similarly extend through the first substrate 1000 and successively through any or all of the layers 1411, 1412, and 1411, leaving only the top release layer 1410 intact. However, because the electrochemical cell is located on the opposite side of the first substrate 1000, the “kiss cut” die, such as a rotary die, may include a pocket or the like to accommodate the electrochemical cell.

Turning now to FIG. 15, in step 8030 at the fifteenth station 6015, the integrated electronic device 999 with the three volt battery can be perforated in the transverse direction along a line 1430 between the trailing edge of one device 999 and an adjacent device 999. The perforations can facilitate separation of the integrated electronic devices 999 from the roll 400. In addition of alternatively, the web of the electronic devices 999 can be slit along the line 1420 to actually separate the devices 999 from each other. Either or both of the slits and the perforations can be performed using various methods, such as a rotary die or the like. Moreover, as discussed above, it can be beneficial to perform the “kiss cut” operation(s) prior to the above-described perforating and/or slitting operations, though either operation can precede the other.

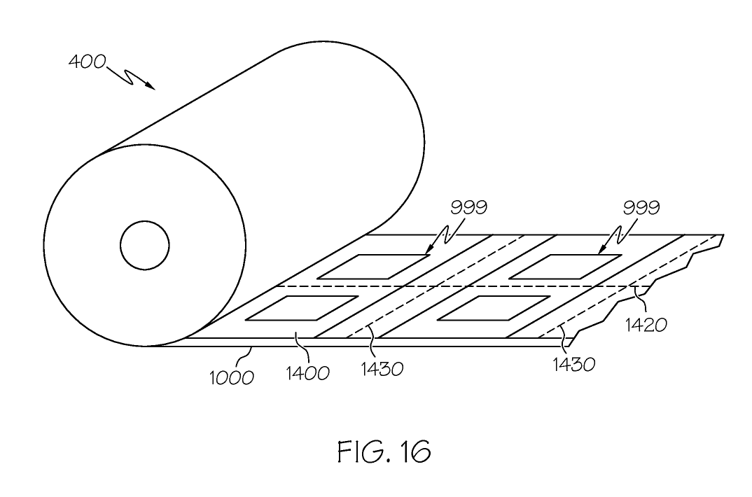

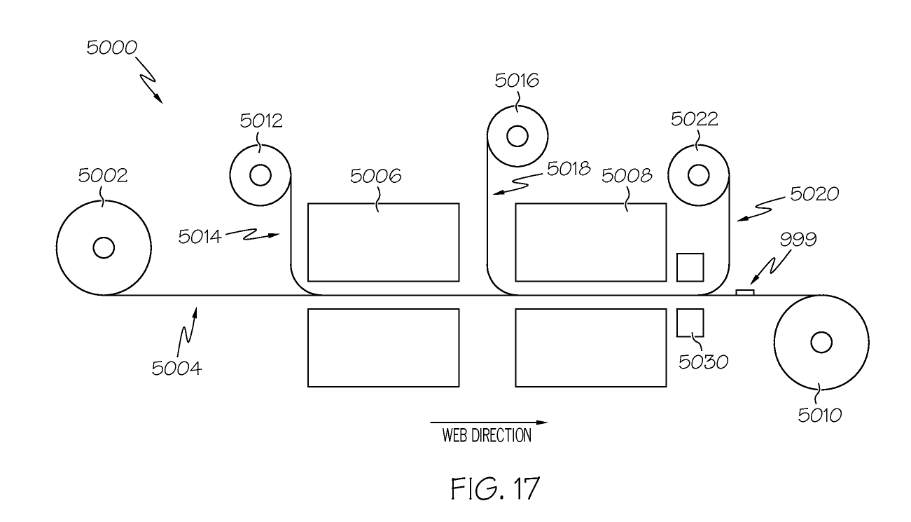

Next, at the final step 8032 illustrated in FIG. 16 (which can be a sixteenth station, not shown), the Iontophoresis devices 999 of a two-wide roll can be

rolled onto a roll 400 for storage, transport. It is to be understood that the devices 999 are illustrated schematically for clarity. Still, the devices 999 can be stored in various other manners. In one example, instead of perforations, the devices 999 can be complete separated from each other along the transverse perforation line 1430, and the devices 999 can be stored as generally flat units. In addition or alternatively, any or all of the four substrates 1000, 1100, 3000, 1400 can be slit on the outside edge thereof to alter a width thereof. Turning now to FIG. 17, a schematic view of an example manufacturing process 5000 of the various steps shown in FIGS. 6-16, is illustrated utilizing a generally continuous web 5004. As discussed herein, any or all of the substrates 1000, 1100, 3000, 1400 can be provided as generally continuous webs that can be processed through a “reel-to-reel” style manufacturing process. For example, the first substrate 1000 can be provided as a generally continuous web 5004 from a source station 5002, which can be a source roll or the like. Some or all of the various processing steps, such as, for example, the steps of providing said cathode layer, providing said anode layer, and electrically coupling the cathode layer, anode layer and the electrodes 401, 501 of the Iontophoresis device, can then be performed by passing the generally continuous web 5004 through a printing station 5008. Though only a single printing station 5008 is illustrated, it is to be understood that multiple printing stations can be utilized. In addition or alternatively, though not illustrated, the process 5000 can be adapted to pass the web 5004 through the printing station 5008 in multiple passes. Finally, the completed Iontophoresis devices 999 on the generally continuous web 5004 can be collected at a take-up station 5010, which can include a collection roll, such as the roll 400 previously described herein.

The manufacturing process 5000 can include various other stages, steps, etc. For example, prior to the printing station 5008, the web 5004 can pass through a preliminary station 5006 wherein various additional elements of the Iontophoresis device 999 can be provided. Moreover, any or all of the various layers, substrates, etc. can be provided by supplemental rolls along the process. For example, a portion of the Iontophoresis devices 999 can be provided by a first supplemental roll 5012 via a supplemental web 5014. In another example, either or both of the second, third, or fourth substrates 1100, 3000, 1400 can be provided by a second supplemental roll 5016 via another supplemental web 5018. Though illustrated near the beginning of the printing station 5008, it is to be understood that any or all of the supplemental webs 5014, 5018 can be provided at various locations along the manufacturing process 5000. Further, the Iontophoresis devices 999 can be “kiss cut” at station 5030. In addition or alternatively, waste material, such as release layers or the like, or even the waste portion matrix from the “kiss cut”, can be removed from as a waste web 5020 and taken-up by a waste roll 5022 or the like. Various other pre-processing and/or post-processing stations, steps, etc. can also be included. It is to be understood that the various stations, rolls, etc. of the described process 5000 can be utilized in various orders, and additional equipment may even be provided (e.g., idler rollers, tension rollers, turn-bars, slit or perforators, etc.) to facilitate the “reel-to-reel” process.

Various other additional steps (not shown) can be utilized to provide additional structure, features, etc. to the completed Iontophoresis devices 999. In one example, an outer portion of the device 999, such as the second substrate 3000 “top cover”, can be provided with a method of attaching the device 999 to another object, surface, etc. For example, the second substrate 3000 can include a pressure sensitive adhesive, another adhesive layer, a hook-and-loop style fastener, a liquid or hot-melt adhesive, etc. In another example, an outer portion of the device 999, such as the second substrate 3000 “top cover”, can be provided with printed indicia or even a label or the like.

In addition or alternatively to the foregoing description, as illustrated in FIG. 13B, it is to be understood that the Iontophoresis structure and the battery power supply can be provided on opposite sides of a substrate, such as on opposite sides of the first substrate 1000. For example, the battery power supply can be manufactured on a first side of the first substrate 1000, while the Iontophoresis structure (i.e., the electrodes 401, 501, fourth substrate 1400 (foam), etc. can be provided on a second side of the first substrate 1000 and coupled thereto by the adhesive layer 1411. Various structure can be provided to electrically couple the battery to the electrodes. In one example, apertures or through holes can extend through the first substrate 1000. The through holes can be located in registration generally with the electrodes 401, 501. Various numbers of through holes can be provided for each contact, such as between one and five holes. The number, location, and/or spacing of the various holes may depend on the application and materials of construction. The holes could be made by several methods such as punching, laser cutting, etc. Moreover, it is to be understood that various other alternatives to the holes can be employed. For example, vias, electrical jumpers, or the like can also be used together with, or as alternatives to, the holes. The various holes, etc. can be provided at various times in the manufacturing process 8000, though it can be beneficial to provide the holes prior to printing either or both of the contacts 602, 604, 606 and/or the electrodes 401, 501 to permit the conductive ink provided for those elements to fill the holes and provide an electrical coupling. Moreover, where elements are formed on both sides of the first substrate 1000, the substrate web may be turned or flipped over using various means, such as a turn-bar arrangement or the like prior to providing elements on the opposite side of the first substrate 1000.

In addition or alternatively, as illustrated in FIG. 13B, the Iontophoresis device can include medicated pads 1650, 1652 within the cavities 1401, 1402. It is to be understood that the medicated pads 1650, 1652 are illustrated schematically for clarity, and although only illustrated in FIG. 13B, it is to be understood that the pads 1650, 1652 can be similarly applied to various other Figures. Each of the medicated pads 1650, 1652 can include electrically charged medicine, cosmetics, etc. Specifically, one of the medicated pads 1650, 1652 can include material having ions bearing a positive charge to be driven across the skin at the site of an electrolytic electrical system anode, while another of the medicated pads 1650, 1652 can include ions bearing a negative charge are driven across the skin at the site of an electrolytic system cathode. As can be appreciated, each medicated pad 1650, 1652 can be located on an appropriate electrode having a corresponding anode or cathode required for proper operation thereof, and can be coupled thereto in various manners. Further, the medicated pads 1650, 1652 can have various sizes, geometries, etc. and may or may not extend a distance beyond the foam substrate 1400. Furthermore, an additional layer can be included on top of any or all of the pads 1650, 1652 to protect the pads and/or ensure retention thereof prior to use by a user. The medicated pads 1650, 1652 can be applied at various stages throughout the manufacturing process, but it can be beneficial to apply the pads 1650, 1652 after application of the foam substrate 1400 to the first substrate 1000.

In addition or alternatively to the foregoing description, though not illustrated, it is to be understood that the Iontophoresis structure and the battery power supply can be provided on different substrates. For example, the battery power source 1530 can be manufactured on a first side of the first substrate 1000, while the Iontophoresis structure (i.e., the electrodes 401, 501, circuitry 602, 603, 606, and 607 can be provided on the first side of a substrate which can be a low cost polymer film such as at about 0.003″ thick. Then in process 5000 these rolls of medical devices are fed through the process on web 5004, then on web 5014 from reel 5012 rolls of completed batteries 1530 are inserted as discrete batteries and attached onto web 5004 and structurally fastened to substrate and electrically connected to the electrodes in station 5006. In another method the batteries on substrate 1000 which were assembled with the same registration as the Iontophoresis device, thus two rolls could be laminated in registration. In both cases various structures can be provided to electrically couple the battery to the electrodes. In one example, apertures or through holes can extend through the first substrate 1000. The through holes can be located in registration generally with the electrodes 401, 501. Various numbers of through holes can be provided for each contact, such as between one and five holes. The number, location, and/or spacing of the various holes may depend on the application and materials of construction. The holes could be made by several methods such as punching, laser cutting, etc. Moreover, it is to be understood that various other alternatives to the holes can be employed. For example, via, electrical jumpers, or the like can also be used together with, or as alternatives to, the holes. The various holes, etc. can be provided at various times in the manufacturing process 8000, though it can be beneficial to provide the holes prior to printing and prior to the lamination of the foam substrate 1400, etc. Substrate 4000 with its precut holes is laminated to the substrates in station 5008 of process 5000. Substrate 4000 is fed into station 5008 by means of reel 5016 and web 5018. After the lamination of the three webs to complete the assembly of the medical device 999, the assembled roll is kiss cut and the excess matrix material is removed, the rolls are slit and/or perforated as required and finally, the completed Iontophoresis devices 999 on the generally continuous web 5004 can be collected at a take-up station 5010, which can include a collection roll, such as the roll 400 previously described herein.

Further, the manufacturing process for this integrated assembly of this medical device could have a different approach which is easily understood to those skilled in the art. The device with its electrodes 401 and 501 and circuitry 602, 603, 606, and 607 is printed on substrate 1000 as previously described. Then in process 5000 these rolls of devices are fed through the process on web 5004, then on web 5014 from reel 5012 rolls of completed batteries 1530 are inserted and attached onto web 5004 and electrically connected to the electrodes in station 5006.

Thin printed flexible batteries can have many potential applications, which can include one or more of the following generally categories as examples:

1. Skin patches that apply Iontophoresis or other electrical function for the purpose of drug delivery, wound care, pain management and/or cosmetics;

2. Advertising and promotion;

3. Toys, novelties, books, greeting cards, and games;

4. Inventory tracking and control such as (smart RFID tags);

5. Security tags;

6. Condition indicators such as temperature, humidity, etc.;

7. RFID assemblies; and

8. Healthcare products such as smart diapers, incontinence products, etc.

The invention has been described hereinabove using specific examples and embodiments; however, it will be understood by those skilled in the art that various alternatives may be used and equivalents may be substituted for elements and/or steps described herein, without deviating from the scope of the invention. Modifications may be performed to adapt the invention to a particular situation or to particular needs without departing from the scope of the invention. It is intended that the invention not be limited to the particular implementations and embodiments described herein, but that the claims be given their broadest interpretation to cover all embodiments, literal or equivalent, disclosed or not, covered thereby.

1. A method of manufacturing an Iontophoresis device including a flat electrochemical cell for generating an electrical current, said method including the steps of:
providing a first substrate and a second substrate, at least one of which includes a plurality of layers;
providing a plurality of electrodes on said first substrate;
providing a cathode layer on said first substrate;
providing an anode layer on first substrate;
providing an electrolyte layer including a viscous liquid in contact with said cathode layer and also in contact with said anode layer;
electrically coupling the cathode layer, the anode layer, and the plurality of electrodes; and
connecting said second substrate to said first substrate to substantially seal said an inner space containing said cathode layer, said anode layer, and said electrolyte layer.

2. The method of claim 1, wherein at least one of the first substrate and the second substrate includes a web having a plurality of layers.

3. The method of claim 1, wherein the step of providing a plurality of electrodes on said first substrate further includes the step of printing said electrodes on said first substrate, wherein each of said electrodes include a cured or dried conductive ink.

4. The method of claim 3, wherein said conductive ink includes at least one of silver, copper, carbon, and zinc.

5. The method of claim 1, further including the step of providing a flexible substrate onto said first substrate, wherein said flexible substrate includes a plurality of layers and a plurality of cavities for receiving the plurality of electrodes and the flat electrochemical cell.

6. The method of claim 5, wherein said flexible substrate includes a foam material layer and an adhesive layer, and wherein said cavities for receiving the plurality of electrodes are adapted to receive medicated pads containing electrically-charged medicine.

7. The method of claim 5, further including the steps of: (i) performing a kiss cut through at least a portion of the layers of the flexible substrate to define a shaped element and a waste matrix, wherein the shaped element generally contains the electrodes and the flat electrochemical cell; and (ii) removing the portion of the flexible substrate corresponding to the waste matrix.

8. The method of claim 1, wherein the step of electrically coupling the cathode layer, the anode layer, and the plurality of electrodes further includes the step of printing a battery contact with a conductive ink between one of the electrodes and the cathode layer, and another of the electrodes and the anode layer.

9. The method of claim 8, wherein the step of printing a battery contact further includes the steps of
(i) providing a plurality cathode layers and a plurality of anode layers;
(ii) printing a first battery contact between a first of the electrodes and a first of the anode layers;
(iii) printing a jumper battery contact between a first of the cathode layers that is associated with said first of the anode layers and a second of the anode layers; and
(iv) printing a second battery contact between a second cathode layer associated with said second of the anode layers and a second of the electrodes, whereby said plurality of cathode layers and anode layers are electrically connected together to form a battery.

10. The method of claim 30, further including the steps of (i) providing the frame as a third substrate including a web having a plurality of laminated layers; (ii) providing cutout cavity extending through said third substrate and oriented so as to be in communication with at portion of said cathode layer and a portion of said anode layer, wherein at least one of said laminated layers is a pressure-sensitive adhesive; and providing a frame sealant disposed on said first substrate generally bounding a perimeter of said inner space, wherein said frame sealant is interposed between said first substrate and said third substrate.

11. The method of claim 1, further including the step of providing one or both of (1) a cathode collector layer between said cathode layer and said first substrate; and (2) an anode collector layer between said anode layer and said first substrate.

12. The method of claim 1, further including the step of providing a paper separator over each of the anode layer and cathode layer that is adapted to absorb at least a portion of the electrolyte layer.

13. The method of claim 1, wherein said cathode layer includes hydroxyethyl cellulose.

14. A method of manufacturing an Iontophoresis device including a flat electrochemical cell for generating an electrical current, said method including the steps of:
providing a first substrate and a second substrate, at least one of which includes a web having a plurality of layers;
printing a plurality of electrodes on said first substrate printing a cathode collector layer on said first substrate;
printing a cathode layer on said first substrate, wherein said cathode layer includes hydroxyethyl cellulose;
printing an anode layer on said first substrate;
providing an electrolyte layer including a viscous liquid in contact with said cathode layer and also in contact with said anode layer;
providing a paper separator over each of the anode layer and cathode layer that is adapted to absorb at least a portion of the electrolyte layer;
electrically coupling the cathode layer via the cathode collector, the anode layer, and the plurality of electrodes; and
connecting said second substrate to said first substrate to substantially seal an inner space containing said cathode layer, said anode layer, and said electrolyte layer.

15. The method of claim 14, wherein the step of providing a plurality of electrodes on said first substrate further includes the step of printing said electrodes on said first substrate, wherein each of said electrodes include a cured or dried conductive ink that includes at least one of silver, copper, carbon, and zinc.

16. The method of claim 14, wherein the step of electrically coupling the cathode layer, anode layer, and the plurality of electrodes further includes the steps of (i) providing a plurality cathode layers and a plurality of anode layers; (ii) printing a first battery contact between a first of the electrodes and a first of the anode layers; (iii) printing a jumper battery contact between a first of the cathode layers that is associated with said first of the anode layers and a second of the anode layers; and (iv) printing a second battery contact between a second cathode layer associated with said second of the anode layers and a second of the electrodes, whereby said plurality of cathode layers and anode layers are electrically connected together to form a battery.

17. The method of claim 14, further including the step of providing a flexible foam substrate onto said first substrate, wherein said flexible substrate includes a plurality of layers and a plurality of cavities for receiving the plurality of electrodes and the flat electrochemical cell, wherein said cavities for receiving the plurality of electrodes are adapted to receive medicated pads containing electrically-charged medicine.

18. The method of claim 14, further including the steps of: (i) performing a kiss cut through at least a portion of the layers of the flexible foam substrate to define a shaped element and a waste matrix, wherein the shaped element generally contains the electrodes and the flat electrochemical cell; and (ii) removing the portion of the flexible substrate corresponding to the waste matrix.

19. An Iontophoresis device including a flat electrochemical cell for generating an electrical current, said Iontophoresis device including:
a first substrate including of a plurality of laminated layers;
a second substrate;
a cathode layer provided on said first side of said first substrate;
an anode layer provided on said first side of said first substrate;
a plurality of electrodes provided on said first substrate and spaced a distance from said cathode layer and said anode layer;
an electrolyte layer including a viscous liquid in contact with said cathode layer and also in contact with said anode layer, wherein at least one of said anode layer and said cathode layer include a cured or dried ink; and
an electrical coupler assembly providing electrical communication between the cathode layer, the anode layer, and the plurality of electrodes.

20. The device of claim 19, wherein said electrical coupler assembly includes a first battery contact between a first of the electrodes and the anode layer, a jumper battery contact between the anode layer and the cathode layer, and a second battery contact between the cathode layer and a second of the electrodes, whereby said cathode and anode layers are electrically connected together to form a battery.

21. The device of claim 19, wherein each of said plurality of electrodes and said electrical coupler assembly is formed from a printed, conductive ink that includes at least one of silver, copper, carbon, and zinc.

22. The device of claim 19, further including a flexible foam substrate coupled to said first substrate by an adhesive, wherein said flexible foam substrate includes a plurality of layers and a plurality of cavities adapted to receive the plurality of electrodes and the flat electrochemical cell, wherein said cavities for receiving the plurality of electrodes are further adapted to receive medicated pads containing electrically charged medicine.

23. The device of claim 22, wherein a portion of the flexible foam substrate defines a shaped element generally containing the electrodes and the flat electrochemical cell, and a waste matrix that is adapted to be removable from the flexible foam substrate.

24. The device of claim 32, wherein said frame is a third substrate including of a plurality of laminated layers and a cutout cavity extending therethrough in communication with at portion of said cathode layer and a portion of said anode layer, wherein at least one of said laminated layers is a pressure-sensitive adhesive.

25. The device of claim 32, wherein said frame is a frame sealant disposed on said first substrate generally bounding a perimeter of said inner space, and wherein said frame sealant is interposed between said first substrate and said frame spacer.

26. The device of claim 19, wherein one or both of (1) a cathode collector layer is provided between said cathode layer and said first substrate; and (2) an anode collector layer is provided between said anode layer and said first substrate.

27. A method of manufacturing an Iontophoresis device including a flat electrochemical cell for generating an electrical current, said method including the steps of:
providing a first substrate;
providing a plurality of Iontophoresis electrodes on said first substrate;
providing a cathode collector layer on said first substrate;
providing a cathode layer on said first substrate;
providing an anode layer on said first substrate;
providing an electrolyte layer in contact with said cathode layer and also in contact with said anode layer; and
electrically coupling the cathode layer via the cathode collector layer, the anode layer, and the plurality of Iontophoresis electrodes by a printed, conductive ink.

28. The method of claim 27, wherein said first substrate is provided as a generally continuous web from a source station, wherein the steps of providing said cathode layer, providing said anode layer, and electrically coupling the cathode layer, anode layer and the plurality of Iontophoresis electrodes are performed by passing the generally continuous web through a printing station, and wherein the completed Iontophoresis device on the generally continuous web is collected at a take-up station.

29. The method of claim 27, wherein said first substrate is provided on a source roll at said source station, and wherein said completed Iontophoresis device is collected on a collection roll a said take-up station.

30. The method of claim 1, further including the step of providing a frame on said first side of said first substrate to form the inner space containing said electrolyte, and also containing at least a major portion of said cathode layer and at least a major portion of said anode layer within said inner space.

31. The method of claim 14, further including the step of providing a frame on said first side of said first substrate to form the inner space containing said electrolyte, and also containing at least a major portion of said cathode layer and at least a major portion of said anode layer within said inner space.

32. The device of claim 19, further including a frame interposed between said first and second substrate to connect and seal said first substrate to said second substrate to form an inner space containing said electrolyte, and also containing at least a major portion of said cathode layer and at least a major portion of said anode layer within said inner space.
